(19) United States
(12) Patent Application Publication
(10) Pub. No.: US 2010/0173619 A1
(43) Pub. Date: Jul. 8, 2010

(54) HEALTHY WEIGHT REMINDER SERVICE VIA WIRELESS NETWORKS

(75) Inventors: Suzann Hua, Lisle, IL (US); Ahmed Zaki, Lisle, IL (US)

Correspondence Address: FAY SHARPE/LUCENT, 1228 Euclid Avenue, 5th Floor, The Halle Building, Cleveland, OH, 44115-1843, US

(73) Assignee: LUCENT TECHNOLOGIES INC., Murray Hill, NJ (US)

(21) Appl. No.: 12/349,701

(22) Filed: Jan. 7, 2009

(51) Int. Cl. H04M 3/493; G06F 9/445; H04W 4/00

(52) U.S. Cl. 455/414.2; 717/174; 455/418

(57) ABSTRACT

A Healthy Weight Reminder (HWR) service that can be offered to a wireless phone subscriber via a wireless handset and network. With this service, a wireless handset upgraded with HWR software will be able to send a weight check reminder to the subscriber periodically and regularly. The subscriber can set up the reminders by specifying the frequency, such as every two weeks, every month, etc. In addition, the HWR service can also compare the subscriber's current weight with the recommended healthy weight and the weight of the last check.

### BACKGROUND OF THE INVENTION

This invention relates to a method and apparatus for providing Healthy Weight Reminder service via wireless networks. While the invention is particularly directed to the art of telecommunications, and will be thus described with specific reference thereto, it will be appreciated that the invention may have usefulness in other fields and applications.

By way of background, a healthy weight is an important factor in maintaining good health. Maintaining a healthy weight may help prevent and/or control many popular diseases, such as heart disease, stroke, diabetes and cancer. From a medical science perspective, both being overweight and being underweight may be an indicator of certain disease risks. As a result, periodically checking weight and maintaining a healthy weight should be important to everyone in today's modern society. However, regardless of such importance, many people are busy with their daily work and life and do not remember to check their weight periodically and regularly.

Currently, there is no way to receive healthy weight reminders via wireless communication devices.

Thus, there is a need for a Healthy Weight Reminder (HWR) service that can be offered to a wireless phone subscriber via a wireless handset and network.

### SUMMARY OF THE INVENTION

This invention relates to a Healthy Weight Reminder (HWR) service that can be offered to a wireless phone subscriber via a wireless handset and network. With this service, a wireless handset upgraded with HWR software will be able to send a weight check reminder to the subscriber periodically and regularly. The subscriber can set up the reminders by specifying the frequency, such as every two weeks, every month, etc. In addition, the HWR service can also compare the subscriber's current weight with the recommended healthy weight and the weight of the last check.

In accordance with an aspect of the invention, a method of providing healthy weight reminder (HWR) service for subscribers in a wireless network is provided. The method includes: receiving a request from a wireless subscriber for HWR service; forwarding HWR service software to the wireless subscriber's user equipment via over-the-air programming; periodically sending updates for the HWR service software to the wireless subscriber's user equipment via over-the-air programming; and deleting the HWR service software from the user equipment upon receiving a cancellation notice from the user.

In accordance with another aspect of the invention, a A method of providing healthy weight reminder (HWR) service for subscribers to Short Message Service (SMS) is provided. The method includes: receiving a request from an SMS subscriber for HWR service; sending an HWR set-up message to the subscriber's user equipment; receiving HWR service set-up information from the subscriber via SMS; sending a healthy weight reminder to the subscriber via SMS; receiving the subscriber's current weight via SMS; and sending the difference between the subscriber's desired weight; and sending the subscriber's current weight to the subscriber via SMS.

In accordance with yet another aspect of the invention, a system for providing healthy weight reminder (HWR) service for subscribers in a wireless network is provided. The system includes: a database for storing HWR data for subscribers and an operations support system. The operations support system is configured to: receive a request from a wireless subscriber for HWR service; forward HWR service software to the wireless subscriber's user equipment via over-the-air programming; periodically send updates for the HWR service software to the wireless subscriber's user equipment via over-the-air programming; and delete the HWR service software from the user equipment upon receiving a cancellation notice from the user.

In accordance with yet another aspect of the invention, a system for providing healthy weight reminder (HWR) service for subscribers to Short Message Service (SMS) is provided. The system includes: a Short Message Service Center configured to receive a request from an SMS subscriber for HWR service, send an HWR set-up message to the subscriber's user equipment, receive HWR service set-up information from the subscriber via SMS, send a healthy weight reminder to the subscriber via SMS, receive the subscriber's current weight via SMS, and send the difference between the subscriber's desired weight to the subscriber via SMS. The system also includes a database for storing the HWR service set-up information.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a diagram of an HWR service architecture suitable for implementing aspects of the present invention;

FIG. 2 is a memory layout of data stored in the database for subscribers in accordance with aspects of the present invention;

FIG. 3 is a call flow illustrating an exemplary service flow for reminders by HWR software in the UE in accordance with aspects of the present invention; and

FIG. 4 is a call flow illustrating an exemplary service flow for reminders by SMS in accordance with aspects of the present invention.

### DETAILED DESCRIPTION

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a flash drive or a hard drive) or optical (e.g., a DVD), and may be read only or random access. Similarly, the transmission medium may be twisted wire pairs, coaxial cable, optical fiber, or some other suitable transmission medium known to the art. The invention is not limited by these aspects of any given implementation.

### HWR Service Architecture

Referring now to the drawings wherein the showings are for purposes of illustrating the exemplary embodiments only and not for purposes of limiting the claimed subject matter, FIG. 1 provides a view of an HWR service architecture into which the presently described embodiments may be incorporated. The major functional components of the architecture include a wireless service provider's network 2, which may include a Short Message Service Center (or SMSC) 4 and Operations Support Systems (or OSS) 6. The wireless network 2 may be a Universal Mobile Telecommunications System (UMTS), a Global System for Mobile communications (GSM), a Code division multiple access (CDMA) system or other known wireless system. For simplicity, only the afore-mentioned network elements are shown. It is to be understood, however, that the network 2 typically includes other network elements as known to those skilled in the art.

A Short Message Service Center is a network element in the wireless telephone network that delivers SMS messages.

Operations Support Systems are special computer systems used by telecommunications service providers. The term OSS most frequently describes “network systems” dealing with the telecom network itself, supporting processes such as maintaining network inventory, provisioning services, configuring network components, and managing faults.

The architecture further includes a user (or subscriber) 8 having one or more types of user equipment (UE) 10, which is any device used directly by an end user to communicate. It can be a hand-held telephone, a PDA, a card in a laptop computer, or any other device. It connects to the base station as specified in the specifications. It is also known as a mobile station. The UE 10 is generally capable of receiving short messages (SMS capable). Further, the UE 10 also includes a screen and memory for storing software.

The network 2 may include at least one HWR database 12 that stores pertinent information for each subscriber. In particular, it may store HWR information for each applicable subscriber.

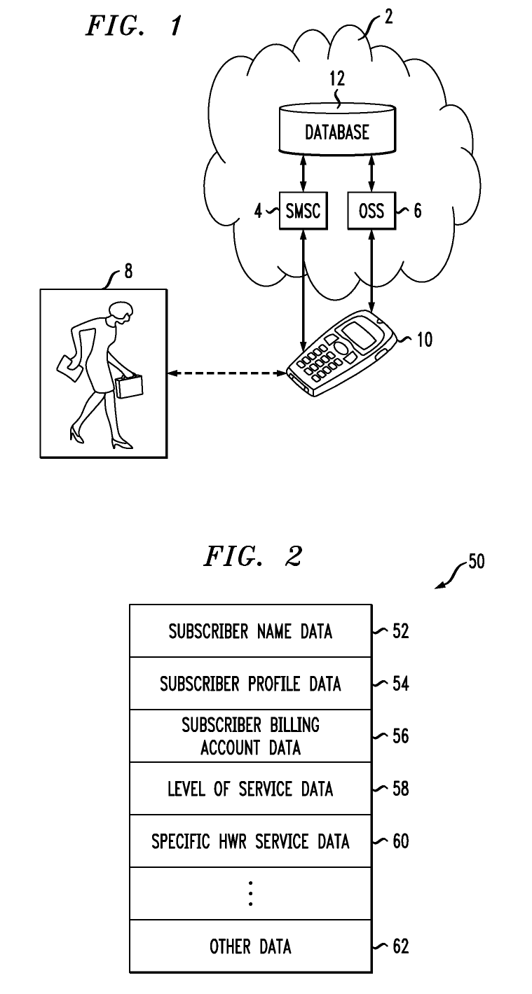

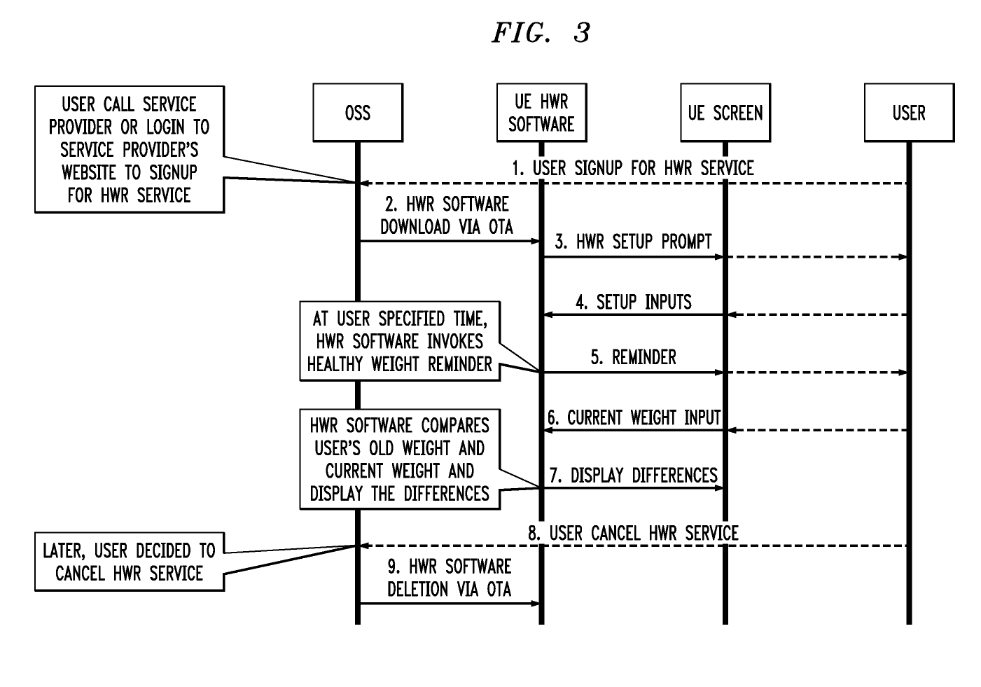

The database 12 generally includes any number of data sub-blocks for each subscriber to HWR service, as shown in FIG. 2. They are shown as a super block 50, not all of whose fields are filled for a particular subscriber. The super block 50, as known in the art, can be accessed from the identity of any one of several fields within it. The super block 50 may include any number of data sub-blocks, such as a first sub-block 52 that contains subscriber name data, a second sub-block 54 that contains subscriber profile data, a third sub-block 56 that contains subscriber billing account data, a fourth sub-block 58 that contains level of service data (whether subscriber has HWR service), and/or a fifth sub-block 60 that contains specific HWR service data for each HWR subscriber such as HWR reminder frequency, requested time of day, current weight, target weight, etc. Of course, any number of additional sub-blocks 62 may be provided in the super block 50 for storing other pertinent subscriber data.

### HWR Service Sign-Up

When a wireless service provider is ready to offer the HWR service, the wireless phone user 8 may go to the service provider's Web site to sign up for the HWR service. After the service sign up is accepted, the service provider's network Operation Support System (OSS) 6 sends the HWR software to the subscriber's UE 10 via Over-The-Air programming. When the user 8 decides to cancel the HWR service, the service provider's network OSS will send another software update to the subscriber's UE that will delete the HWR software. Therefore, the user will not be able to use the HWR service without a subscription. In this way, the service provider will be able to charge the subscriber for the HWR service.

Note that the HWR software on the UE 10 may be periodically updated by the OSS 6 as needed.

In the case of SMS, after the service sign up is accepted, the SMSC 4 sends HWR messages to the subscriber's UE 10. When the user 8 decides to cancel the HWR service, the SMSC 4 will send a message to the database 12 to update the subscriber's records. Therefore, the user will not be able to use the HWR service without a subscription. In this way, the service provider will be able to charge the subscriber for the HWR service.

### Configuring HWR Service

After the subscriber's UE 10 is upgraded with the HWR software, the UE 10 will ring. The user will then be prompted to configure or set up the HWR service to input various types of information. The user may be prompted to:
a. select an HWR frequency, with options of 2 weeks, one month, bi-monthly, etc.;
b. select one or more times that the reminder is to be sent;
c. input the user's current weight;
d. input the doctor recommended healthy weight; and
e. if the user does not know doctor's recommended healthy weight, then the HWR software may prompt the user to input his/her height, gender, activity level, etc., which can be used to calculate the generally recommended healthy weight.
   Of course, it is to be understood that other types of pertinent information relating to HWR service may be input by the user.

Of course, the HWR service configuration procedure may be accomplished via SMS. In that case, the subscriber's HWR service information is stored in the database 12.

### How HWR Service Works

After the HWR service is setup by the user, at the specified time the HWR software will send the user the healthy weight reminder periodically and regularly as user setup. The reminder will ring user's phone and display a text such as “It is time to check your weight, please input your current weight now.” The user may then go weigh and input the current weight. The HWR software can then compare the current weight with the stored doctor recommended healthy weight or generally recommended healthy weight, and indicate the difference to the UE 10. The HWR software can also compare the subscriber's current weight with the subscriber's weight last checked, and indicate the difference to the UE 10.

As stated, the HWR service can also be offered by the Short Message Service Center 4 of the wireless network 2. In that case, the user 8 receives reminders via SMS.

In addition, the HWR service software and corresponding data may be stored in the network database 12 or on a network server. In that case, reminders may be sent directly from the OSS 6 to the UE 10.

### HWR Service Flows

FIG. 3 is a call flow for HWR service via software downloaded to and stored in the UE 10:
1. Initially, the user 8 signs up for HWR service (via the Internet, for example).
2. The HWR software is downloaded to the UE 10 via Over-The-Air programming.
3. An HWR set-up prompt is sent.
4. The user 8 sets up the HWR service on the UE 10.
5. Reminders are sent to the user 8 via the UE 10.
6. The user 8 may input their current weight and other pertinent information.
7. The difference between the desired weight and the current weight as well as the difference between the last weight and the current weight may be displayed.
8. At some point, the user 8 may decide to cancel the HWR service.
9. Upon receipt of a cancellation message, the HWR software is deleted from the UE 10 via Over-The-Air programming.

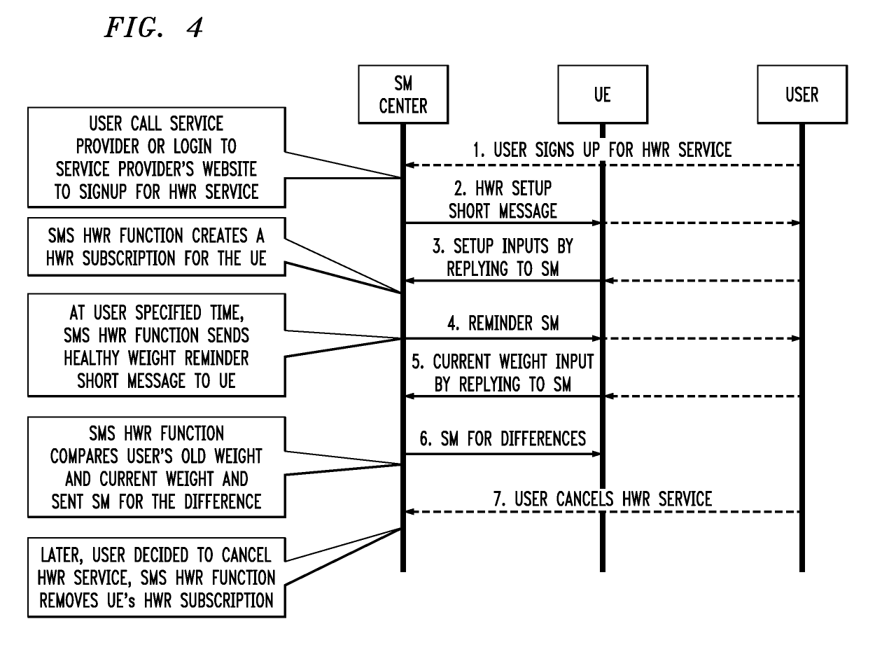

FIG. 4 is a call flow for HWR service via SMS:
1. Initially, the user 8 signs up for HWR service (via the Internet, for example).
2. An HWR set-up message (SMS) is sent to the user 8 via the UE 10.
3. The user 8 sets up the HWR service by replying to the short message.
4. SMS reminders are sent to the user 8 via the UE 10.
5. The user 8 may input their current weight and other pertinent information via SMS.
6. The difference between the desired weight and the current weight as well as the difference between the last weight and the current weight may be displayed.
7. The user 8 may decide to cancel the HWR service. Upon receipt of a cancellation message, the HWR database 12 is updated to reflect the subscriber's new status.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of providing healthy weight reminder (HWR) service for subscribers in a wireless network, the method comprising:
receiving a request from a wireless subscriber for HWR service;
forwarding HWR service software to the wireless subscriber's user equipment via over-the-air programming; and
deleting the HWR service software from the user equipment upon receiving a cancellation notice from the user.

2. The method of claim 1, further comprising:
periodically sending updates for the HWR service software to the wireless subscriber's user equipment via over-the-air programming.

3. The method of claim 1, wherein the wireless network comprises a UMTS, a GSM, or a CDMA system.

4. The method of claim 1, wherein the HWR service software includes instructions to prompt the subscriber to configure the HWR service with one or more types of data.

5. The method of claim 4, wherein the data includes one or more of the following: a reminder frequency, a time of day to send the reminder, the subscriber's current weight, and a desired healthy weight.

6. The method of claim 4, further comprising:
where the subscriber does not know a doctor's recommended healthy weight, prompting the subscriber to input personal data that is used to calculate the generally recommended healthy weight for the subscriber.

7. The method of claim 4, wherein the HWR software periodically prompts the subscriber to enter a current weight and then displays the difference between the subscriber's desired healthy weight and the subscriber's current weight.

8. A method of providing healthy weight reminder (HWR) service for subscribers to Short Message Service (SMS), the method comprising:
receiving a request from an SMS subscriber for HWR service;
sending an HWR set-up message to the subscriber's user equipment;
receiving HWR service set-up information from the subscriber including the subscriber's desired healthy weight via SMS;
sending a healthy weight reminder to the subscriber via SMS;
receiving the subscriber's current weight via SMS;
sending the difference between the subscriber's current weight and the subscriber's desired healthy weight to the subscriber via SMS.

9. The method of claim 8, wherein the HWR service set-up information further includes a reminder frequency and a time of day to send the reminder.

10. The method of claim 9, further comprising:
storing the HWR service set-up information in an HWR service database.

11. The method of claim 9, further comprising:
where the subscriber does not know a doctor's recommended healthy weight, prompting the subscriber to input personal data that is used to calculate the generally recommended healthy weight for the subscriber.

12. A system for providing healthy weight reminder (HWR) service for subscribers in a wireless network, the system comprising:
a database for storing HWR data for subscribers; and
an operations support system configured to:
receive a request from a wireless subscriber for HWR service;
forward HWR service software to the wireless subscriber's user equipment via over-the-air programming; and
delete the HWR service software from the user equipment upon receiving a cancellation notice from the user.

13. The system of claim 12, wherein the operations support system is further configured to periodically send updates for the HWR service software to the wireless subscriber's user equipment via over-the-air programming.

14. The system of claim 12, wherein the wireless network comprises a UMTS, a GSM, or a CDMA system.

15. The system of claim 12, wherein the HWR service software includes instructions to prompt the subscriber to configure the HWR service with one or more types of data.

16. The system of claim 15, wherein the data includes one or more of the following: a reminder frequency, a time of day to send the reminder, the subscriber's current weight, and a recommended healthy weight.

17. The system of claim 15, wherein the HWR software includes instructions to prompt the subscriber to input personal data that is used to calculate the generally recommended healthy weight for the subscriber where the subscriber does not know a doctor's recommended healthy weight.

18. The system of claim 15, wherein the HWR software periodically prompts the subscriber to enter a current weight and then displays the difference between the subscriber's desired healthy weight and the subscriber's current weight.

19. A system for providing healthy weight reminder (HWR) service for subscribers to Short Message Service (SMS), the system comprising:
a Short Message Service Center configured to:
receive a request from an SMS subscriber for HWR service;
send an HWR set-up message to the subscriber's user equipment;
receive HWR service set-up information from the subscriber including the subscriber's desired healthy weight via SMS;
send a healthy weight reminder to the subscriber via SMS;
receive the subscriber's current weight via SMS; and
send the difference between the subscriber's current weight and
the subscriber's desired healthy weight to the subscriber via SMS; and
a database for storing the HWR service set-up information.

20. The system of claim 19, wherein the HWR service set-up information further includes a reminder frequency and a time of day to send the reminder.

21. The system of claim 20, wherein the Short Message Service Center is further configured to prompt the subscriber to send via SMS personal data that is used to calculate the generally recommended healthy weight for the subscriber where the subscriber does not know a doctor's recommended healthy weight.
